(19) United States
(12) Patent Application Publication
(10) Pub. No.: US 2023/0258149 A1
(43) Pub. Date: Aug. 17, 2023

(54) SOOT EXHAUST GAS RECIRCULATION SEPARATOR

(71) Applicant: Spencer Ekstam, Union, MO (US)

(72) Inventor: Spencer Ekstam, Union, MO (US)

(21) Appl. No.: 17/873,999

(22) Filed: Jul. 26, 2022

Related U.S. Application Data
(60) Provisional application No. 63/309,244, filed on Feb. 11, 2022.

(51) Int. Cl. F02M 26/35; F02M 26/05; F02M 26/23; F02M 26/11

(52) U.S. Cl. CPC F02M 26/35; F02M 26/05; F02M 26/23; F02M 26/11

(57) ABSTRACT

An exhaust gas recirculation (EGR) system with a diesel particulate filter (DPF) incorporated before the EGR cooler to filter the particulate matter from the EGR before entering the air intake. With the DPF installed before the EGR cooler soot buildup in all EGR components and air intake track is reduced or eliminated. Installing the DPF before the EGR cooler allows the DPF to be in passive regeneration while the vehicle's engine is in operation, extending the life and maintenance interval of the DPF. Alternatively, the DPF may be installed after the EGR cooler, reducing or eliminating soot buildup in the EGR valve and air intake.

### CROSS REFERENCE TO RELATED APPLICATION

This application claims the benefit of co-pending application Ser. No. 63/309,244, filed on Feb. 11, 2022, entitled SOOT EXHAUST GAS RECIRCULATION SEPARATOR.

### FIELD

The present invention relates generally to an exhaust gas recirculation system, and more particularly, to an exhaust gas recirculation system that separates soot from the exhaust gas before entering the exhaust gas recirculation cooler.

### BACKGROUND

With strict emissions standards in place for modern vehicle manufacturers, all were required to implement complex emission control systems. To reduce the production of greenhouse gases exhaust gas recirculation (EGR) systems have become mandatory for both on-road and off-road diesel applications. Since exhaust gases are not combustible, a varying portion of the exhaust gases are rerouted from the vehicle's exhaust system back to the intake. These gases travel through an EGR cooler to bring them to a manageable temperature in order to enter the intake air stream. An EGR valve is commanded to increase or decrease flow depending on what the engine control module is commanding. Once the exhaust gases have entered the intake, the air/fuel becomes diluted or less combustible which reduces the extreme combustion temperatures that produce greenhouse gases.

Although these emissions systems greatly reduce the harmful pollutants such as nitrogen oxide (NOx) produced by an internal combustion engine, they also create problems that did not exist before EGR systems being mandatory. The more noticeable problems for a diesel engine equipped with an EGR system is soot accumulation. Soot, which is comprised mainly of carbon particles, is a natural substance created by the combustion cycle of a diesel engine.

In a high-pressure EGR system (HP EGR), exhaust gas is routed from the exhaust manifold, before the turbine through the EGR cooler to the intake manifold after the turbo compressor. Because the exhaust gas passes through the EGR cooler first, soot is deposited in the EGR cooler. When the exhaust gas is rapidly cooled, moisture in the gas condenses, which traps the soot. Over time, the soot begins to build up and clogs the EGR cooler, which must be replaced. Likewise, the EGR valve becomes coated with soot for the same reasons as the EGR cooler resulting in improper function or complete failure.

On an EGR equipped engine the engine oil will show increases in soot content, acidity, viscosity, and particle buildup. The oil will also run at higher temperatures because the same engine coolant that is being used to cool the oil is also being used to cool the EGR. For every 18° F. increase over 140° F. in oil temperature, the oil's oxidation rate doubles and reducing service life by half.

In SAE case study 1999-01-0839, the effects of EGR on diesel engine wear was measured. On a 1.0-liter single cylinder diesel engine with EGR levels of 10%-15% they saw 10%-15% increase wear on the piston rings and cylinder walls. The also observed degrading oil quality because of the increased soot in the system. Since EGR systems are mandatory, there is a need to combat the issues that are created by them.

There is a need in a high-pressure EGR system to protect the EGR cooler and the EGR valve from soot and other diesel particulates to extend the life of these components and to prevent clogging.

### SUMMARY

The present invention incorporates a diesel particulate filter (DPF) into the EGR system before the EGR cooler to filter the particulate matter from the EGR before entering the air intake. Adding a DPF to the EGR system reduces or eliminates the negative side effects of soot buildup keeping all emission components clean and functioning. Additionally, reducing or eliminating soot being introduced back into the engine improves engine reliability and increases service intervals. With the DPF installed before the EGR cooler soot buildup in all EGR components and air intake track is reduced or eliminated. Installing the DPF before the EGR cooler allows the DPF to be in passive regeneration while the vehicle's engine is in operation, extending the life and maintenance interval of the DPF. Alternatively, the DPF may be installed after the EGR cooler, reducing or eliminating soot buildup in the EGR valve and air intake.

### BRIEF DESCRIPTION OF THE DRAWINGS

FIG. 1 is a prior art illustration of an exhaust gas recirculation system.

FIG. 2 is an illustration of an embodiment of the exhaust gas recirculation system of the present invention.

FIG. 3 is a sectional side view of a diesel particulate filter.

FIG. 4 is an end view of the diesel particulate filter of FIG. 3.

### DETAILED DESCRIPTION

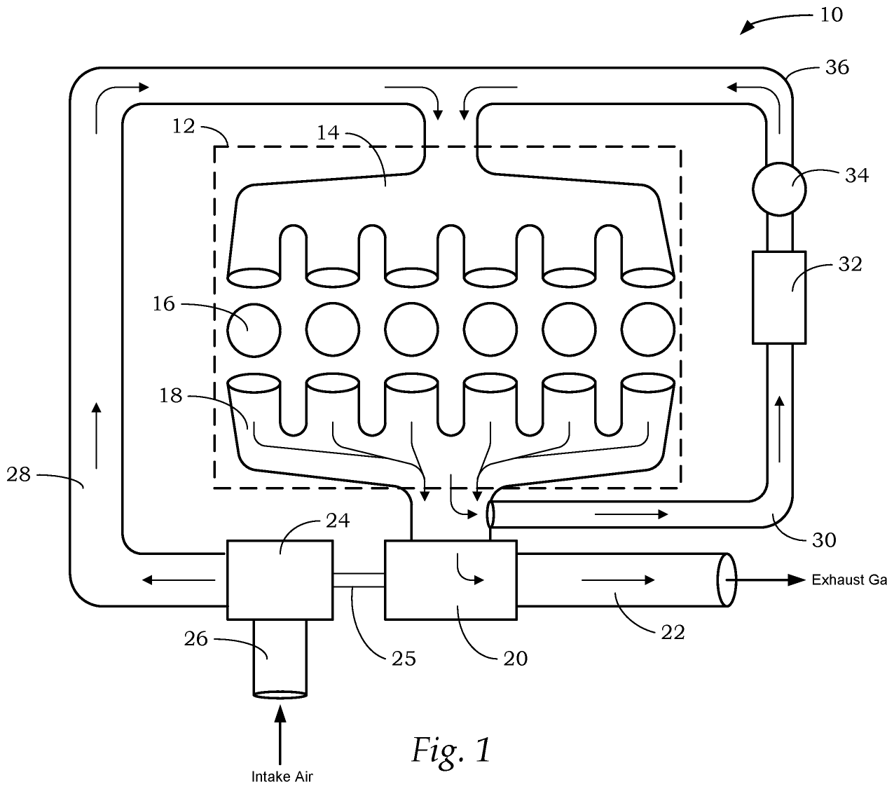

Referring initially to FIG. 1, a prior art exhaust gas recirculation (EGR) system for a diesel engine is generally indicated by reference numeral 10. EGR system 10 includes an engine 12 with an air intake manifold 14, cylinders 16 and an exhaust manifold 18. A turbine 20 is connected to the exhaust manifold and driven by the exhaust gas which exits though an exhaust pipe 22. The turbine 20 drives a compressor 24 via drive shaft 25, which compresses air received through an air intake 26, and delivers the compressed air to the intake manifold 14 through a compressed air pipe 28. A portion of the exhaust from the exhaust manifold 18 is also routed through an EGR exhaust pipe 30 to an EGR cooler 32 and EGR valve 34 to the air intake manifold 14 through outlet pipe 36. In this prior art configuration, as the exhaust gas passes through the EGR cooler 32 and EGR valve 34, soot accumulates in the EGR cooler 32 and EGR valve 34 decreasing the efficiency and efficacy of these devices leading to failure, and costly replacement or repair. Further, the soot also abrades the pistons, piston rings, and cylinder walls of the engine, and decreases the life of the engine oil.

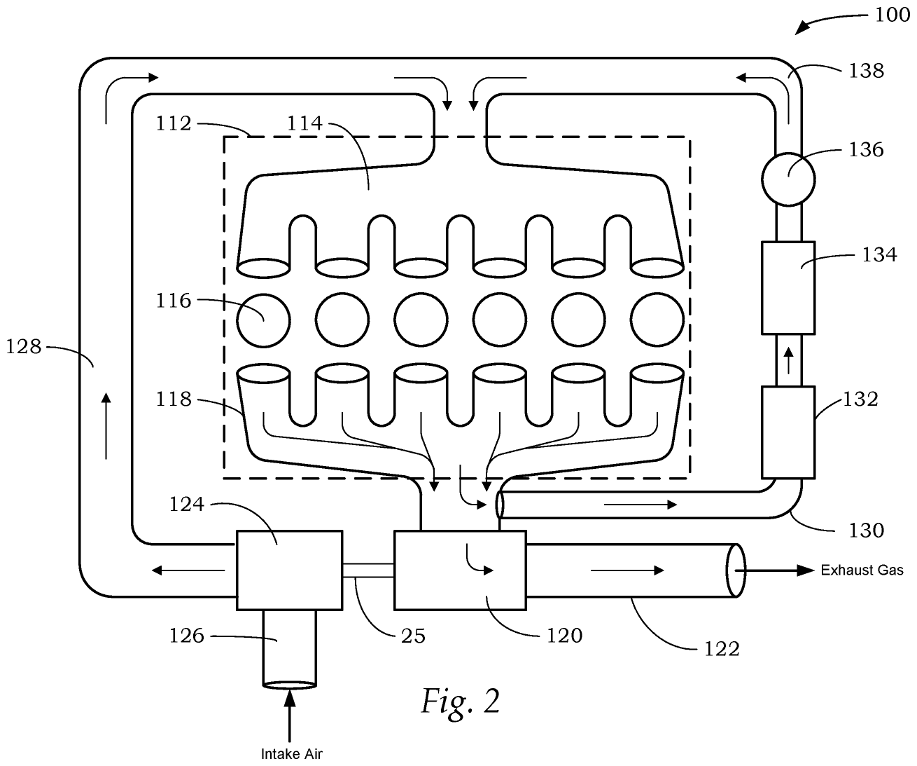

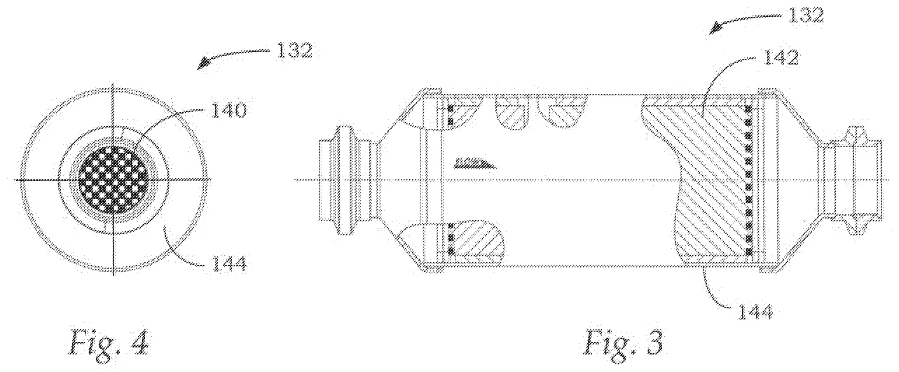

Referring to FIG. 2, an improved EGR system for a diesel engine is generally indicated by reference numeral 100. EGR system 100 includes an engine 112 with an air intake manifold 114, cylinders 116 and an exhaust manifold 118. A turbine 120 is connected to the exhaust manifold and driven by the exhaust gas which exits though an exhaust pipe 122. The turbine 120 drives a compressor 124, which compresses air received through an air intake 126, and delivers the compressed air to the intake manifold 114 through a compressed air pipe 128. A portion of the exhaust from the exhaust manifold 118 is also routed through an EGR exhaust pipe 130 through a diesel particulate filter (DPF) 132, an EGR cooler 134 and EGR valve 136 to the air intake manifold 114 through outlet pipe 138. The soot and particles in the exhaust gas are filtered by the DPF 132 before reaching the EGR cooler 134, EGR valve 136 and intake manifold 114. Alternatively, the DPF 132 may be installed after the EGR cooler 134, reducing or eliminating soot buildup in the EGR valve 136 and intake manifold 114.

The DPF 132 may include a honeycomb substrate 140 or wire mesh for example, that is coated with a diesel oxidation catalyst (DOC), such as a platinum group metal (PGM) catalyst to speed up oxidation of the particulate matter (PM). Using a coated DOC allows for passive regeneration of the DPF 132 at a lower temperature. Typically, the regeneration process requires a temperature of at least 550° F. to begin regeneration, but the higher the temperature the quicker and more efficient the burn off of the PM in the DPF 132 will be. Exhaust gas temperatures may range from 300° F. to 1400° F. depending on the load on the engine 112.

The DPF 132 is the filter 142 inside the casing 144 that physically captures the PM. The DPF 132 may be a PGM coated ceramic wall filter that is very porous to allow air flow but capture the PM. From the ends, the filter resembles a honeycomb but only every other passage is open. Each passage is open on one end and closed on the other, thus forcing the dirty exhaust gasses through the wall of the filter. Using the wall of the filter instead of only the face of the filter allows greater particulate capacity. Depending on the filter element, approximately 85% of the PM may be filtered from the ERG Stream, and 50% to 98% or greater of the PM removal from the EGR stream may be achieved.

It is to be understood that while certain now preferred forms of this invention have been illustrated and described, it is not limited thereto except insofar as such limitations are included in the following claims. Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

1. An exhaust gas recirculation system in combination with an air intake and exhaust of a diesel engine comprising:
a diesel engine having an air intake manifold, cylinders, and an exhaust manifold;
a turbine coupled to the exhaust manifold and driven by an exhaust gas exiting through an exhaust pipe, and having a drive shaft;
a compressor coupled to the drive shaft of the turbine and driven to compress air received from an air intake and transfer said compressed air to the intake manifold; and
a high pressure exhaust gas recirculation exhaust pipe coupled to said exhaust manifold to receive a high pressure portion of said exhaust gas therefrom and route said high pressure portion of said exhaust gas to a diesel particulate filter, coupled to an exhaust gas recirculation cooler, coupled to an exhaust gas recirculation valve, and coupled to said air intake manifold via an outlet pipe;
wherein a portion of particulate matter carried by said high pressure portion of said exhaust gas is filtered by said diesel particulate filter.

2. The exhaust gas recirculation system of claim 1 wherein said diesel particulate filter removes greater than 50 percent of the particulate matter from said high pressure portion of said exhaust gas.

3. The exhaust gas recirculation system of claim 1 wherein said diesel particulate filter removes approximately 85 percent of the particulate matter from said high pressure portion of said exhaust gas.

4. The exhaust gas recirculation system of claim 1 wherein said diesel particulate filter removes greater than 90 percent of the particulate matter from said high pressure portion of said exhaust gas.

5. The exhaust gas recirculation system of claim 1 wherein said diesel particulate filter includes a substrate material coated with platinum group metal.

6. The exhaust gas recirculation system of claim 1 wherein said diesel particulate filter includes a honeycomb substrate.

7. An exhaust gas recirculation system in combination with an air intake and exhaust of a diesel engine comprising:
a diesel engine having an air intake manifold, cylinders, and an exhaust manifold;
a turbine coupled to the exhaust manifold and driven by an exhaust gas exiting through an exhaust pipe, and having a drive shaft;
a compressor coupled to the drive shaft of the turbine and driven to compress air received from an air intake and transfer said compressed air to the intake manifold; and
a high pressure exhaust gas recirculation exhaust pipe coupled to said exhaust manifold to receive a high pressure portion of said exhaust gas therefrom and route said high pressure portion of said exhaust gas to an exhaust gas recirculation cooler, coupled to a diesel particulate filter, coupled to an exhaust gas recirculation valve, and coupled to said air intake manifold via an outlet pipe;
wherein a portion of particulate matter carried by said high pressure portion of said exhaust gas is filtered by said diesel particulate filter.

8. The exhaust gas recirculation system of claim 7 wherein said diesel particulate filter removes greater than 50 percent of the particulate matter from said high pressure portion of said exhaust gas.

9. The exhaust gas recirculation system of claim 7 wherein said diesel particulate filter removes approximately 85 percent of the particulate matter from said high pressure portion of said exhaust gas.

10. The exhaust gas recirculation system of claim 7 wherein said diesel particulate filter removes greater than 90 percent of the particulate matter from said high pressure portion of said exhaust gas.

11. The exhaust gas recirculation system of claim 7 wherein said diesel particulate filter includes a substrate material coated with platinum group metal.

12. The exhaust gas recirculation system of claim 7 wherein said diesel particulate filter includes a honeycomb substrate.

13. An exhaust gas recirculation system in combination with an air intake and exhaust of a diesel engine comprising:
a diesel engine having an air intake manifold, cylinders, and an exhaust manifold;
a turbine coupled to the exhaust manifold and driven by an exhaust gas exiting through an exhaust pipe, and having a drive shaft;
a compressor coupled to the drive shaft of the turbine and driven to compress air received from an air intake and transfer said compressed air to the intake manifold; and
a high pressure exhaust gas recirculation exhaust pipe coupled to said exhaust manifold to receive a high pressure portion of said exhaust gas therefrom and route said high pressure portion of said exhaust gas to a diesel particulate filter, coupled to an exhaust gas recirculation cooler, coupled to an exhaust gas recirculation valve, and coupled to said air intake manifold via an outlet pipe;
wherein a portion of particulate matter carried by said high pressure portion of said exhaust gas is filtered by said diesel particulate filter;
wherein said diesel particulate filter includes a honeycomb substrate coated with a diesel oxidation catalyst.

14. The exhaust gas recirculation system of claim 13 wherein said diesel particulate filter removes greater than 50 percent of the particulate matter from said high pressure portion of said exhaust gas.

15. The exhaust gas recirculation system of claim 13 wherein said diesel particulate filter removes approximately 85 percent of the particulate matter from said high pressure portion of said exhaust gas.

16. The exhaust gas recirculation system of claim 13 wherein said diesel particulate filter removes greater than 90 percent of the particulate matter from said high pressure portion of said exhaust gas.

17. The exhaust gas recirculation system of claim 13 wherein said diesel particulate filter includes a substrate material coated with platinum group metal.
